(19) United States
(12) Patent Application Publication
(10) Pub. No.: US 2010/0158653 A1
(43) Pub. Date: Jun. 24, 2010

(54) Hose entry system

(76) Inventors: Daniel Webb, Forest Reefs (AU); Tim Smith, Forest Reefs (AU); Collin O'Shaughnessy, Borenore (AU); Craig Healey, Orange (AU); John Healey, Orange (AU)

Correspondence Address: BERGMAN & SONG, LLP, P.O. BOX 400198, CAMBRIDGE, MA, 02140, US

(21) Appl. No.: 12/590,613

(22) Filed: Nov. 9, 2009

(30) Foreign Application Priority Data
May 8, 2007 (AU) 2007902451
May 6, 2008 (AU) PCT/AU2008/000634

(51) Int. Cl. E02F 9/14; B23P 11/00

(52) U.S. Cl. 414/722; 29/428

(57) ABSTRACT

A method of constructing a boom assembly of a front end loader, including the step of providing connection of a first and second boom member 12, 14 with a cross bar 24 via a pair of shaped plates 30 which strengthen said connection while providing means for a hose to pass through said first or second boom to a location outside of said cross bar. Additional cabling plates can be provided, the additional plates providing a radiused duct 19.79 for the passage of a hose. The additional plates can include a passageway 19.71 for electrical wiring.

### CROSS-REFERENCE TO RELATED APPLICATIONS

The present application is a US National Phase application under 35 USC §371 and claims priority to PCT Patent Application number PCT/AU2008/000634 having an International Filing Date of May 6, 2008 which, in turn, claims priority to Australian patent application number 2007902451 having a filing date of May 8, 2007, the disclosures of which are both herewith incorporated by reference in their respective entireties.

### FIELD OF THE INVENTION

The present invention relates to front end loaders and similar equipment which utilises hydraulic hoses and hydraulic cylinders, and can also be adapted to accommodate electrical wires and cables.

### BACKGROUND OF THE INVENTION

Front end loaders comprise a boom and several hydraulic cylinders to motivate implements mounted to the boom. Hoses pose many difficulties for designers of hydraulic equipment, and these being on the outside of the boom arms or members are susceptible to damage. When damaged hoses can pose a risk to persons in the vicinity of the damaged hose. Similarly, electrical wires and cables can be abraded or otherwise damaged, for example by bending stresses or chaffing on metal corners etc.

Any reference herein to known prior art does not, unless the contrary indication appears, constitute an admission that such prior art is commonly known by those skilled in the art to which the invention relates, at the priority date of this application.

### SUMMARY OF THE INVENTION

According to a first embodiment, the invention provides a hose protector adapted to be attached to a hollow arm having an aperture for a hose to be inserted into the interior of the boom member, wherein the edges of the aperture or protector are radiused.

The hose protector can be formed to facilitate maintaining the bend of the hose at a radius greater than a minimum bending radius.

The protector can include an electrical wire or cable opening or channel.

The invention also provides a method of constructing a boom assembly of a front end loader, the method including the step of providing connection of a first and second boom member with a cross bar via a pair of shaped plates which strengthen the connection while simultaneously providing means for a hose to pass through the first or second boom to a location outside of and in the vicinity of the cross bar.

The cross bar can be welded at each of its ends to respective plates.

Each of the plates can be respectively welded to the first and second boom.

The present invention also provides a shaped plate adapted to connect a cross bar to a boom of a front end loader, the plate having a periphery which is adapted to be connected to the boom and a boss around an aperture through the plate, the aperture receiving the cross bar, the boss having a rim on an end of the boss away from the plate such that the lineal length of the rim is considerably larger than the lineal length of a circumference or perimeter of the cross bar measured perpendicular to a longitudinal axis of the cross bar.

The plate can include a second aperture through the plate for a hose to pass through the second aperture.

The second aperture can be surrounded by a boss.

The boss can be used for one of or more than one of the following: securing the hose to the plate; directing the hose through the plate; securing a cover to the plate to overlie the hose.

The second aperture has, at its rim on the boom side of the plate, a radius to prevent a hose being damaged by the plate.

The periphery of the plate can be adapted to be welded to the boom.

The present invention also provides a metal hose chute through which a hydraulic hose can pass when passing through a wall of a structural member, the chute being characterised by including a periphery surrounding a first aperture, the periphery being adapted to be welded to the structural member and a wall extending away from the periphery leading to a second aperture, the wall having a radius to cause a hose passing through the first and second apertures to be angularly displaced from those portions of the hose not in the chute.

The chute can cause the hose to be angularly displaced in the range of 20 degrees to 90 degrees.

The first aperture and or the second aperture can be round or has at least one rounded end.

The first aperture can be obround.

The rims of the first or second apertures can be radiused.

The present invention also provides a boom assembly for a front end load, the assembly including first and second boom members with a cross bar interconnecting the first and second boom members, the cross bar being adapted to carry components of a hydraulic system at least on the outside thereof, the assembly including a cowling system extending between the boom members and overlying the cross bar.

The cross bar can be joined to respective ones of the boom members by a shaped plate, the plates providing support and securement for the cowling system.

The cowling system can be made from one or more cowling pieces.

The cowling system can be constructed from at least two end pieces and one centre piece.

The cowling system can include apertures for hoses to pass into or out of the volume bounded by the cowling system.

The apertures can be covered by panels which are popped out or removed when required.

The present invention further provides a method of constructing a boom assembly of a front end loader, the method including the step of providing connection of a first and second boom member with a cross bar having an internal cavity, and mounting within the internal cavity components of a motive power means for powering cylinders associated with the boom assembly or implements thereon, the components being secured within the cavity by means of brackets which are compressed between an wall of the cavity and the component to immobilise the bracket and the component relative to the cross bar.

The method can include the steps of first inserting the bracket into the cavity and then inserting the component into the bracket forcing the bracket to be compressed between the component and the wall of the cavity.

The method can include the steps of first locating the component within the cavity then inserting the bracket into the cavity between the component and the wall of the cavity.

The component can be an accumulator.

The motive power means can be an hydraulic, or pneumatic system.

The present invention also provides a method of constructing a boom assembly of a front end loader, the method including the step of providing connection of a first and second boom member with a cross bar, the method including the step of joining the cross bar to the first and second boom member at an inboard and outboard location where the cross bar and boom members intersect and the step of attaching a plate via its perimeter to one of the inboard or outboard surfaces of the boom members, the plate surrounding the cross bar, and joining the plate to the cross bar at a rim of the plate which surrounds the cross bar.

The plate can have a perimeter which includes at least two opposed rounded ends, such as an obround or round perimeter.

The plate can include a corrugated rim surrounding the cross bar.

The plate can include a cylindrical wall extending between the rim and a base of the plate.

The plate can include a boss formed on said plate from which said cylindrical wall extends.

The plate can include a hose entry aperture.

The present invention also provides a bracket for mounting a component of a hydraulic or pneumatic system within the confines of a cavity of a structural member, said bracket including an external shape complementary to the internal shape of said cavity, the bracket including an internal recess to receive the component, the bracket jamming the component in the cavity when the bracket is first positioned in the cavity and the component is inserted in the bracket, or the component is first inserted in the cavity and the bracket is then interposed between the component and a wall of the cavity thereby jamming the component in the cavity.

The recess and the external shape can be sized so that when the bracket is in use the elasticity and rigidity of the material from which the bracket is made will maintain the component jammed in the cavity.

The bracket can be made of a polymeric material.

The bracket can include an off centre recess to receive the component.

The bracket can include a passageway to allow hoses or cables associated with the component to pass by the bracket.

The bracket can include at least one compressible formation which is elastically biased against compressive forces.

The formation can be a wall portion which is either cantilevered from a supporting formation or is supported at spaced apart locations, and wherein the bias is supplied by the elasticity of the walls and or the supports.

In this specification and claims, the term “obround” is used to described a general geometric shape. At the time of writing this specification and claims very few English dictionaries define this word. Notwithstanding, the word is used herein to describe a shape consisting of two semicircles connected by parallel lines tangent to their endpoints, which generally looks as follows:

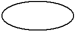

### BRIEF DESCRIPTION OF THE DRAWINGS

An embodiment or embodiments of the present invention will now be described, by way of example only, with reference to the accompanying drawings, in which:

FIG. 1 illustrates a perspective view of a boom arrangement;

FIG. 2 illustrates a hose entry casting which provides for support and hose entry functions;

FIG. 2A illustrates the hose entry casting of FIG. 2 which has been cross sectioned through a vertical plane;

FIG. 3 illustrates the hose entry casting of FIG. 2 in cutaway view in use;

FIG. 4 illustrates a perspective view of the apparatus of FIG. 2 in use;

FIG. 5 illustrates hose entry castings used on the boom of FIG. 1;

FIG. 6 illustrates a perspective view on a hose chute of FIG. 5;

FIG. 7 illustrates in perspective view the other hose chute of FIG. 5;

FIG. 8 illustrates a cross section in the direction of arrow VIII-VIII of FIG. 5;

FIG. 9 illustrates a part cutaway view of the boom member of FIG. 5 showing the hose chutes of FIGS. 6 and 7 in situ;

FIG. 10 illustrates a perspective view showing a cowling in position over a cross bar of a boom assembly with the left side of the boom cut away; and

FIG. 11 illustrates a detailed perspective view of the left side of the apparatus of FIG. 10, where the cross bar meets the boom;

FIG. 12 illustrates a cross section view through FIG. 11 showing how the cowling and cross bar interacts with a hose entry casting;

FIG. 13 illustrates a perspective from the rear of the right hand side of the boom assembly;

FIG. 14 illustrates a sectioned perspective view of boom assembly showing the right hand side of the boom assembly;

FIG. 15 illustrates the right hand side of the boom assembly in section view-with valve block and solenoids present;

FIG. 16 illustrates a perspective view of a bracket used to mount accumulators within the cross bar;

FIG. 17 illustrates a perspective view of the bracket of FIG. 16 from the opposite direction to that viewed in FIG. 16; and

FIG. 18 illustrates a half view of the bracket of FIGS. 16 and 17 within the confines of a cross bar having an accumulator therein.

FIG. 19 illustrates a first view of an embodiment of a chute adapted to accommodate electrical wires;

FIG. 20 is a second view of the chute of FIG. 19;

FIG. 21 is a section view of the arrangement of FIG. 4 illustrating the welds;

FIG. 22 is an illustration of the chute of FIG. 19 installed in an boom member;

FIG. 23 is an interior illustration of the arrangement of FIG. 22;

FIG. 24 is a section view of the arrangement of FIG. 22 along line IX.

### DETAILED DESCRIPTION OF THE EMBODIMENT OR EMBODIMENTS

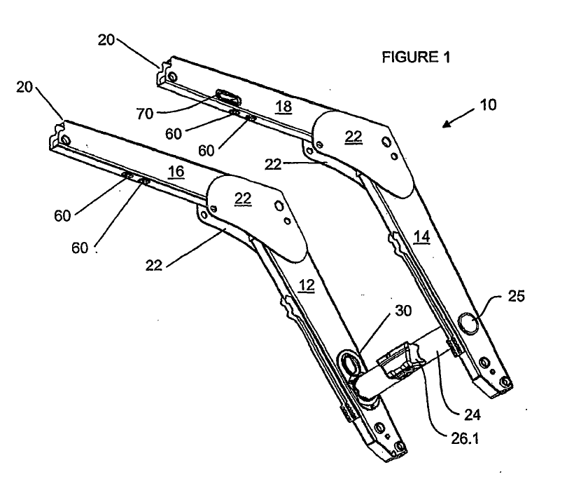

Illustrated in FIG. 1 is a boom assembly 10 having lower booms members 12 and 14 being the left and right hand sides of the boom 10 respectively. The boom assembly 10 also has upper boom members 16 and 18 being respectively the left and right hand sides of the boom 10. The rearward ends 20 of the upper boom members 16 and 18 would be attached to posts which will allow for connection to mating posts on a tractor or similar implement. The upper and lower boom members 12, 14, 16 and 18 are respectively secured by welded plates 22 with a respective plate 22 on each side of each of the left and right hand side boom members.

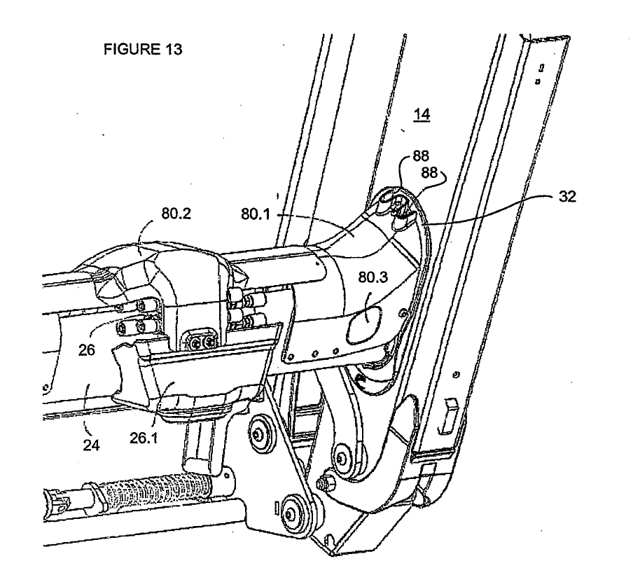

At the lower end of the lower boom members 12 and 14 these boom members are joined by a cross bar 24 on which is mounted a valve mount 26.1 to mount a valve block 26 (as illustrated in FIGS. 13, 14 and 15). The valve block 26, which might also be a ported block, allows for the connection of accumulators and other hydraulic or pneumatic control equipment thereto.

It will be seen from FIG. 1 that the cross bar 24 connects to the lower boom members 12 and 14 via a hose entry plate casting 30 on their respective inboard locations. The arrangement is such that the cross bar 24 is welded at three separate locations to the lower boom members 12, 14. The cross bar 24 passes through the outboard surfaces of the lower boom members 12 and 14 and sits proud of the outboard surfaces of the lower boom members 12 and 14 by approximately 6 mm as shown at 25, allowing a sufficient amount of cross bar 24 to be welded to the outboard surface of the lower boom members 12 and 14, to form the first weld location all the way around the outside circumference of the cross bar 24 outboard of the lower boom members 12, 14. The second weld location is all the way around the outside circumference of the cross bar 24 inboard of the lower boom members 12, 14, which will lie adjacent to the chamfer 35, when the hose entry casting 30 is assembled. The third weld is formed by welding into place the hose entry casting 30 on the inboard side of the lower boom members 12, 14. The hose entry casting is first welded to the inboard face of the boom members 12, 14 around its obround perimeter. Once welded then the cross bar 24 is welded to the corrugated rim 36 of the cylindrical wall 38. By this means the cross bar is welded at three locations to the lower boom members 12, 14, thus making for a better and stronger attachment than by comparison with the prior art, which by virtue of the hose entry casting 30, allows the bearing of greater torsional loads between the cross bar 24 and lower booms 12, 14.

In the upper boom members 16 and 18 can be seen castings 60 and 70 which are illustrated in more detail in FIGS. 6 and 7 respectively.

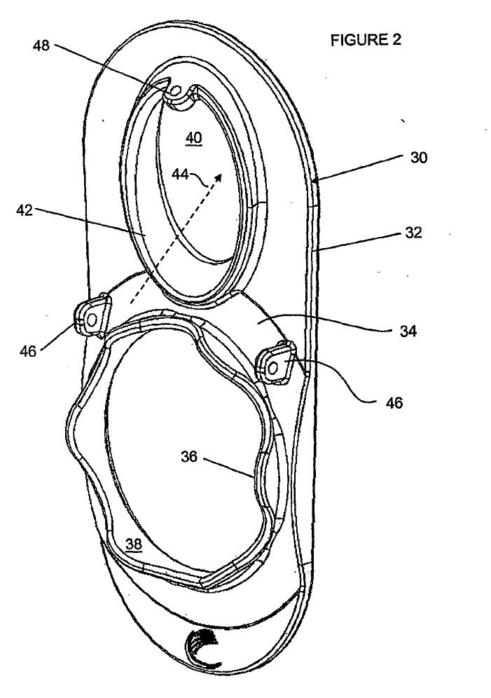

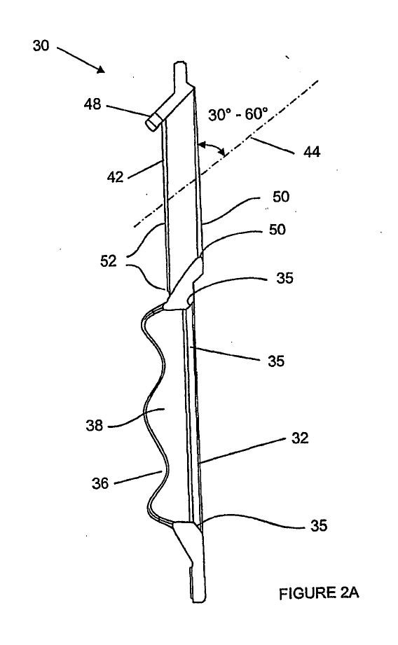

Illustrated in FIG. 2 is the plate casting hose entry shown in greater detail.

The hose entry plate casting 30 includes a base plate 32 and a boss 34 which extends away there from. The boss 34 terminates in a corrugated rim 36 and has a generally cylindrical wall 38 through the middle thereof. A hose aperture 40 is provided above the boss 34 which is surrounded by an oblique cylindrical or elliptical wall 42 which has a longitudinal axis 44 which lies at an angle of approximately 30° to 60° to the plane of the rear face of the plate casting 32, as is illustrated in the cross section of FIG. 2A.

The hose entry casting 30 includes a bevel or chamfer 35 at the intersection where the cylindrical wall 38 meets the rear face of the base plate 32. The purpose of the chamfer 35 will be described in more detail below.

The hose entry plate casting 30 also includes mounting tabs 46 on the boss 34 and a mounting tab 48 on the elliptical wall 42. The mounting tabs 46 and 48 provide on one side of the boom assembly 10 a three point securement or side for a cover to overlie the cross bar 24 so as to hide componentry and hoses which sit adjacent the cross bar 24 and which may pass through the aperture 40 and which will proceed to the valve or ported block 26.

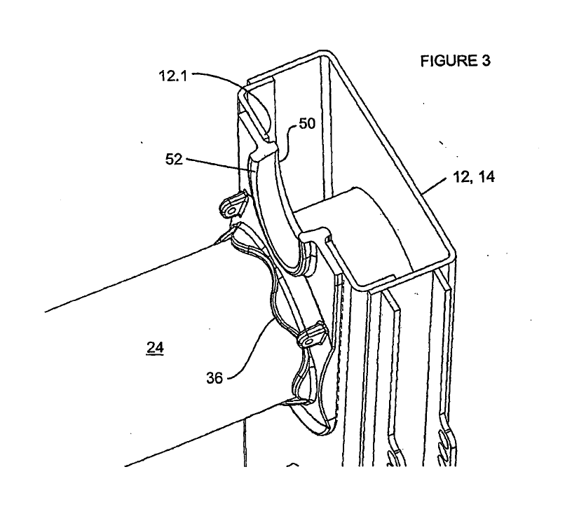

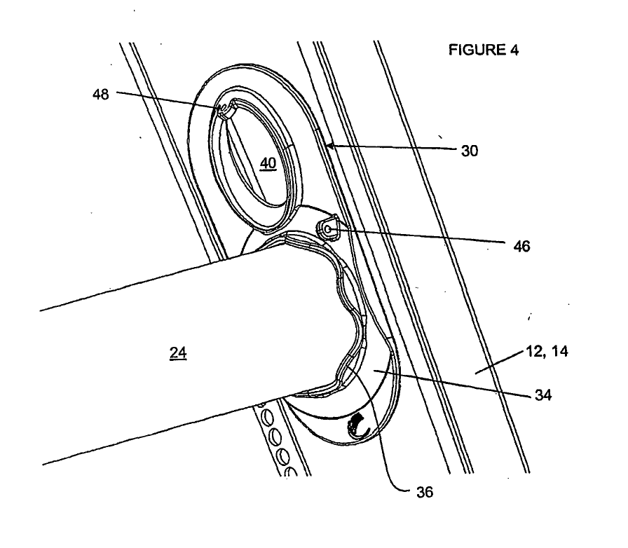

As is illustrated in the cutaway section of FIGS. 3 and 4 the cross member 24 passes through the cylindrical wall 38 so that the rim 36 lies adjacent to the outer circumference of the cross bar 24. By providing a corrugated rim 36 the cross bar 24 can be welded along a much longer weld than if the rim 36 were circular in nature.

The outer obround periphery of the plate 32 allows the plate 32 to be welded to the inboard side of the lower boom member 12, 14. As will be seen from FIG. 3 the hose aperture 40 is provided whereby a smooth radiused or rounded inner edge 50 and outer edge 52 The inner edge 50 extends from the rear plane of plate 32 in the outboard direction of the lower boom member 12, 14, by a greater distance than the thickness of the side member 12.1 of the lower boom member 12.

By the angle of the axis 44 to the plane of the rear plate 32 is selected to allow a hose which passes down through the lower boom member 12, 14 from the upper boom member 16, 18, to form an easy curve or bend in the hose without risk of kinking or other blockages occurring. Further by the edges 52 and 50 being radiused or rounded, the natural vibrations and movements of a hose under pressure (as pressure is decreased and increased) therein will not cause damage to the hose and its outer surfaces.

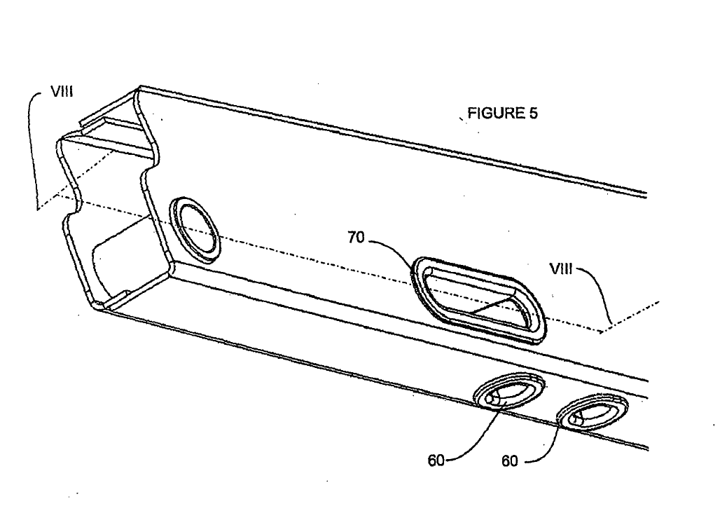

Illustrated in FIG. 5 is the upper boom member 16, 18 more clearly showing the chutes 60 and 70.

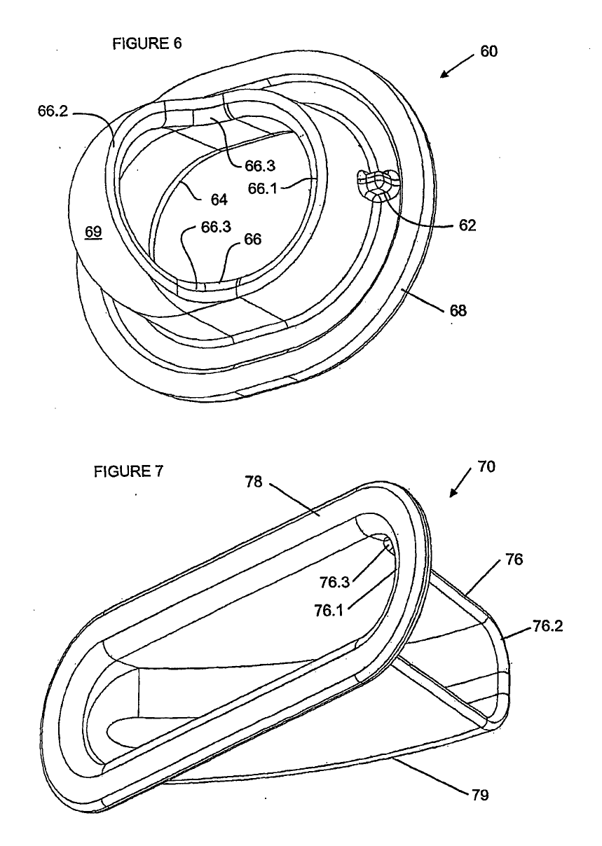

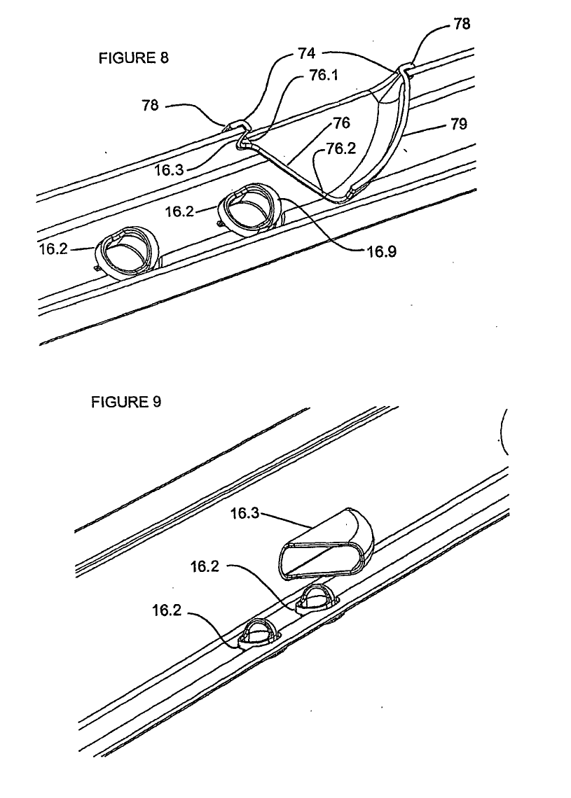

As illustrated in FIG. 6 the chute 60 is of a button type arrangement, generally circular or having a minor elongation of a major axis or is generally obround as is illustrated in FIG. 6. On an inside edge as part of the flange 68 is a locator 62 which will prevent rotation when the locator 62 is located in a notch in a hole provided in the side wall of the boom member. This is more clearly visible in FIG. 8.

The chute 60 has two apertures, one being bounded by rim 64 on the outside surface of the boom member and an internal aperture bounded by rim 66 which has a portion 66.1 which is parallel to the upper plate 68 and a portion 66.2 which is generally perpendicular thereto with radiused portions 66.3 intermediate portions 66.2 and 66.1. The outside periphery or flange 68 allows the chute 60 to be welded to the outside of the upper boom members 16, 18 and helps to provide strength to that region of the boom member where the aperture 16.2 is illustrated in FIG. 8 has been cut into the boom member. Preferably the chute 60 is made from cast steel.

Illustrated in FIG. 7 is a obround chute similar to that of FIG. 6 with a like parts being like numbered except that the prefix number 7 is used instead of the prefix number 6. One difference between the chutes of FIGS. 6 and 7 is that the chute 70 of FIG. 7 has a greater or more pronounced more obround characteristic. That is, the straight sides are much longer than the chute 60 of FIG. 6 and further the edge of the aperture 76 in the region of 76.2 is at more of an oblique angle to the flange 78 than being approximately 90° to flange 68 as is the case of the edge 66.2. The chutes 60 and 70 of FIGS. 6 and 7 provide a smooth transition for hoses passing into and or out of the upper boom members 16, 18 and provide rounded edges at the rims of the apertures 74, 76, 66 and 64 whereby no damage will occur to the hoses passing therethrough from these edges with the rear curved walls 69 and 79 providing a relatively smooth transition as the plane through which the hoses and the angular displacement of the hoses through these locations will undertake. The transition of curved wall 79 may have a curvature which is constant, or which progressively reduces in radius from opening 76.2 to opening 76.1, provided that the minimum radius is greater than a minimum bending radius for the hose.

Further the outer rims 78 and 68 provide a welding location which will ensure that the apertures 16.2 and 16.3 which are cut in the boom member side wall to accommodate the chutes 60 and 70 are reinforced by the chutes 60 and 70 once they are welded around their rim, whereas without such fittings a hole cut therein would be a point of weakness in the boom member.

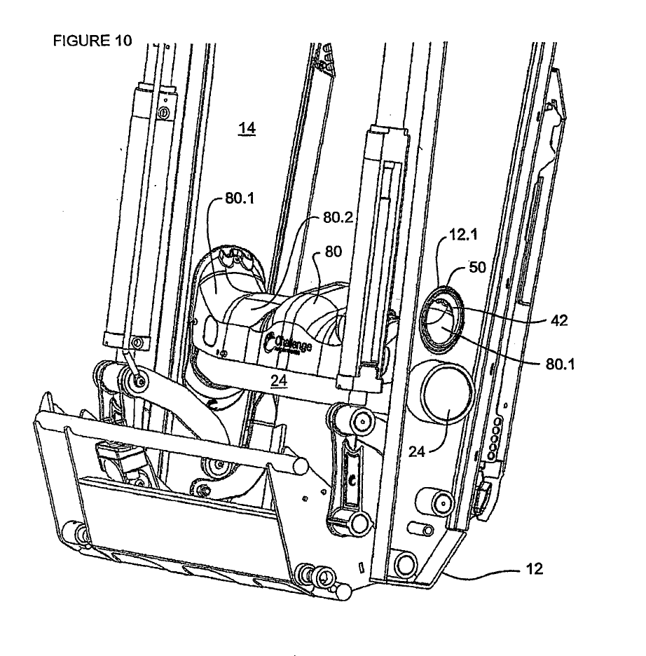

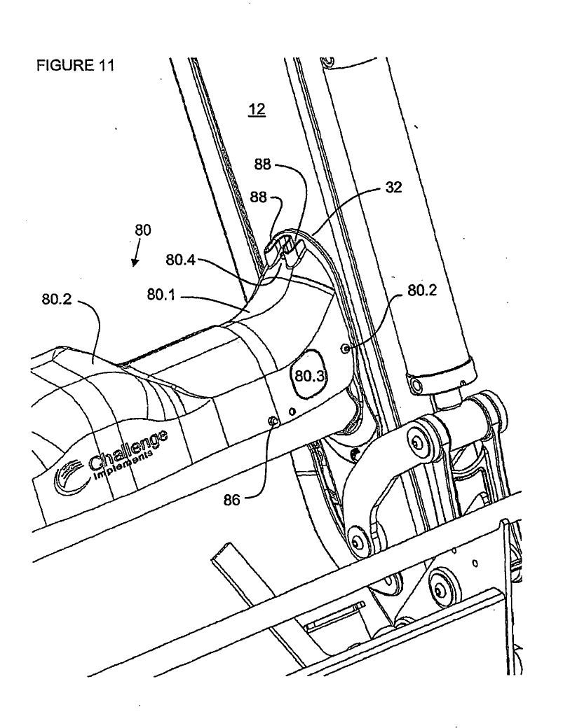

Illustrated in FIGS. 10 to 12, is the lower most end of the boom assembly 10 of FIG. 1. As can be seen from FIG. 10 the boom assembly 10 includes a three piece cowling 80, made up of outer pieces 80.1 which are identical, simply reversed in use, and a centre piece 80.2. The outer pieces 80.1 and centre piece 80.2 which overlie the “upper” portion of the cross bar 24, to cover, hide and protect the valve block 26 and the hoses which pass underneath the cowling 80, and into the lower booms 12, 14. The outer pieces 80.1 include panels 80.3, which are formed integrally with the pieces 80.1, but which can be popped out if desired to allow ingress and egress of hoses through the aperture formed when the panel 80.3 is separated from the piece 80.1.

At the upper region of the outer piece 80.1 are two holes 88 with bosses or flanges around them, to allow hoses to pass into and out of the outer piece 80.1 from the valve block 26 to hydraulic cylinders such as crowd cylinders.

As can be seen from FIGS. 10 to 12, the cowling outer pieces 80.1 are secured to the hose entry plate casting 30 by means to three machine screws 82 and 84, while the centre piece 80.2 is secured by means of 4 dome headed nuts onto bolts or studs welded to the outside of the cross bar 24.

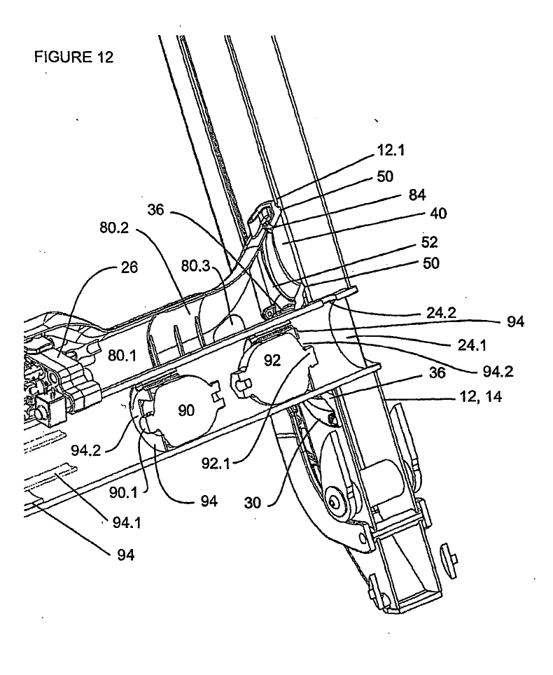

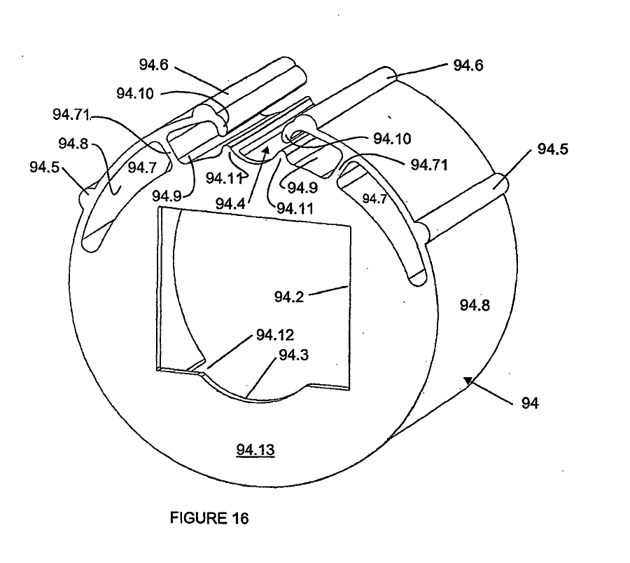

Illustrated in FIG. 12 can be seen two accumulators 90 and 92 which are located within the cross bar 24, mounted in polymeric brackets 94 therein. The brackets 94 are illustrated in more detail in FIGS. 16 to 18.

The brackets as seen from FIGS. 16 to 18, have a generally cylindrical shape as illustrated by the generally circular shape of the face 94.13. The face 94.13 has a generally square/rectangular aperture 94.2, with one side having bight or scallop 94.3 therein. The bight 94.3 accommodates the caps 90.1 and 92.1 of the accumulators 90 and 92 respectively. The square/rectangular aperture 94.2 is arranged on the bracket 94 so as to be approximately central to the cross bar 24 when installed therein.

The bracket 94 includes two discontinuous walls 94.8 which at the top are separated by a gap 94.4 and at the bottom are separated by a gap 94.12. The walls 94.8 have their inner circumference which has a centre which is off set from the centre of the outside circumference. This off centre forms a cavity or recess in which to receive the outer circumference or diameter of the accumulators 90, 92. By the inner circumference being offset from the outer circumference the accumulators 90 and 92 will sit in the bracket 94 in the lower portion thereof. Because it does this, the bight 94.3 is required so that the caps 90.1 and 92.1 can pass through the wall 94.13.

In the upper region of the walls 94.8, in order to conserve material and to provide the functional locking requirements, the walls 94.8 have a hollow 94.7 and a channel 94.9, separated by a wall 94.71, to form a bifurcated terminus having cantilevered end 94.10 at the top and end 94.11 at the bottom. Over the hollow 94.7 is a protruding ridge 94.5 and on the cantilevered end is a protruding ridge 94.6

The gap 94.4 provides a passage, when the bracket is mounted in the cross bar 24, between the inner wall of the cross bar 24 and the bracket 94, for hoses to pass over and through the brackets 94 to allow passage of hydraulic or pneumatic fluids under pressure between the accumulators 90, 92 and the valve block 26.

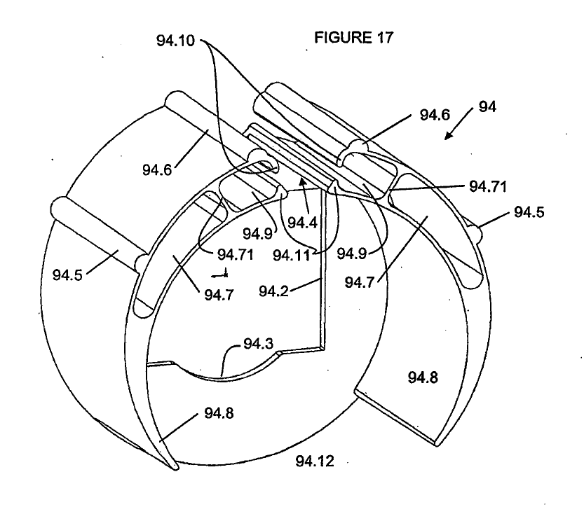

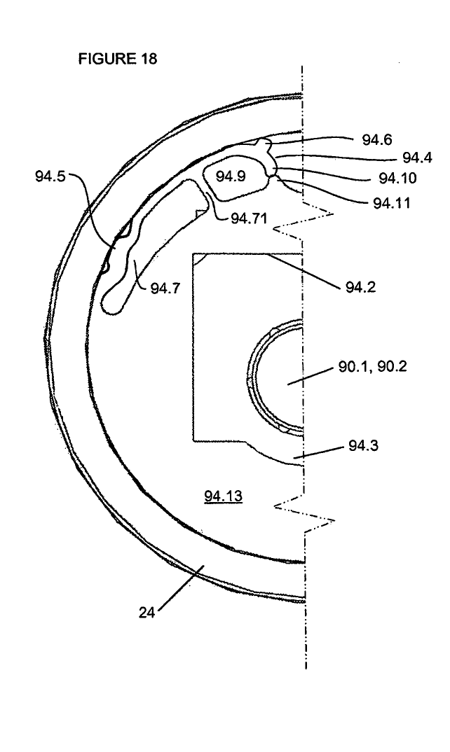

As illustrated in FIG. 18 the ridge 94.5 by means of the hollow 94.7 and the ridge 94.6 by virtue of the cantilevered end 94.10 will be compressed when placed in the cross bar 24, and by their dimensional relationship of the inner diameter of the cross bar and the radial length to the extremity of the ridges 94.5 and 94.6 will cause deformation of the external wall of the cavity 94.7 and cause the end 94.10 to engage the end 94.11 preventing further relative movement.

The geometry of the bracket 94 allows either the bracket to be first inserted into the cross bar 24, with the accumulator 90, 92 being inserted sequentially, or for the bracket to be placed on the accumulator 90, 92 then the both of them simultaneously inserted into the cross bar 24.

When assembled in the cross bar 24, as illustrated the polymeric brackets 94 are reversed with respect to each other, with the inboard bracket and or accumulator being installed first. By the shape and size of the bracket 94, this will lock against the internal cylindrical surface of the cross bar 24. This locking force is further assisted by the compressive force provided when the accumulator 90 is installed in the bracket 94.

If the accumulators are not previously joined by a T-piece before placing in the cross bar 24, then once accumulator 90 is installed, then the accumulator 92 is connected to the accumulator 90, and the outboard bracket 94 pushed in around the accumulator 92, locking the accumulator 92 and the bracket in place in the cross bar 24. The cross bar 24 can then be capped off by a plastic cap 24.1, which can be provided with an aperture to allow any water which may enter the cross bar 24 to exit therethrough.

If the accumulators are previously joined by a T-piece then the last step remaining is to push a bracket 94 into position to lock the accumulator 92 into position.

Before assembly of the accumulators 90, 92 into the cross bar 24, preferably the hose connections are made so that once the accumulators and brackets are inserted into the cross bar then the hose/hoses will be emanating from the cross bar end.

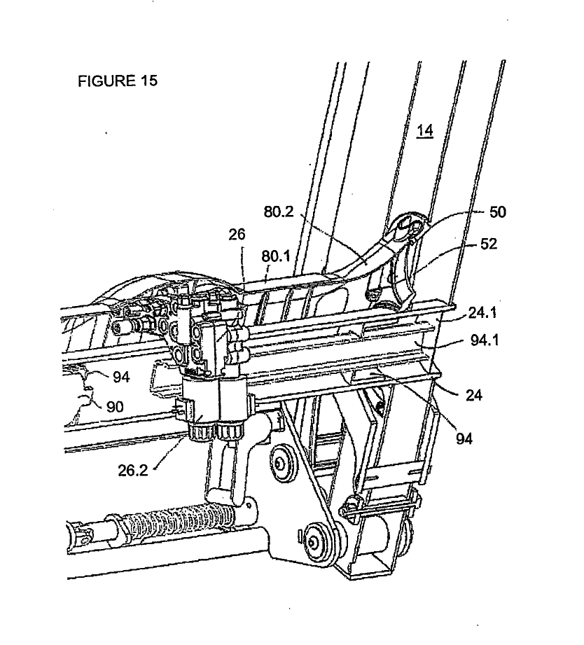

The brackets 94 have centrally located generally rectangular or square aperture 94.2 through which the caps of the accumulators pass. However these square apertures 94.2 allow other brackets 94 as illustrated in FIG. 15 to be positioned inside the other end of the cross bar 24 (opposite to the side which has the accumulators 90 and 92), so that within the apertures 94.2 can be positioned such things as tools or a cylinder lock 94.1 (being an elongated C or U shape cross sectioned member), where they can await retraction by an operator for use with the boom assembly 10.

On the top of the cross bar 24 and located internally of the lower boom members 12, 14, is an aperture 24.2. This aperture 24.2 allows a hose or hoses to pass from the accumulators 90 and 92 out of the cross bar 24, and then into the internal cavity of the lower boom member 12, 14, then through the aperture 40, via the curved edges 50 and 52, to make its way to the valve block 26 under the cover of the cowling 80 and its outer and centre pieces 80.1 and 80.2 respectively.

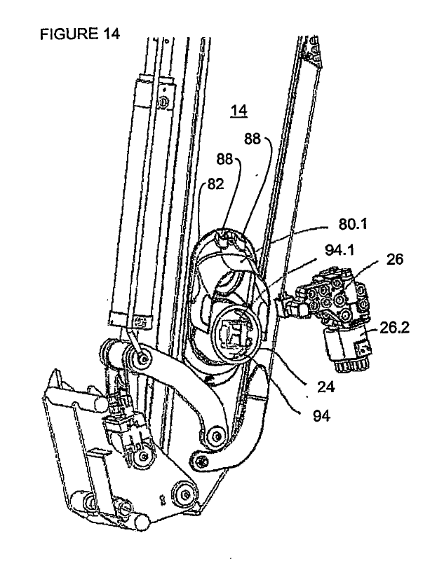

As illustrated in FIGS. 13, 14 and 15 the valve block 26 and solenoids 26.2 form a generally L-shaped arrangement. This is best seen in FIGS. 14 and 15, where the cross bar 24 has been removed or partly removed and shows how the L-shaped arrangement sits with respect to the cross bar 24. When the implement end of the boom assembly 10 close to the ground, the L-shaped configuration is located on top of and behind the cross bar 24. In this way the valve block 26 and the solenoids 26.2 are protected when the boom assembly 10 is in its most vulnerable orientation when tramming or operating.

It will be noticed from the perspective view of FIG. 13, that the cowling centre piece 80.2 covers mainly the top and forward section of the cross bar 24. The rear view shows that the connections of the hoses (not illustrated) to the valve block 26 are visible by the operator and are thus able to have a visual inspection by the operator in the cabin of the tractor to which the boom assembly 10 is attached.

As is illustrated in FIGS. 1 and 13, the valve mount 26.1 is attached to the rearward side of the cross bar 24, when the boom assembly 10 is in its lowermost orientation. The valve mount 26.1 is of a pouch shaped construction with rearward, left right and lower side walls, with the rear surface of the cross bar 24 forming the forward wall of the pouch. The valve block 26 with its attached and downwardly depending solenoids 26.2 is then mounted to the cross bar 24 via the valve mount 26.1. When the centre cowling piece 80.2 is assembled onto the cross bar 24, the piece 80.2 and the valve mount 26.1 and cross bar 24 are arranged to help to ensure that the valve block and its solenoids are protected from accidental collision during use.

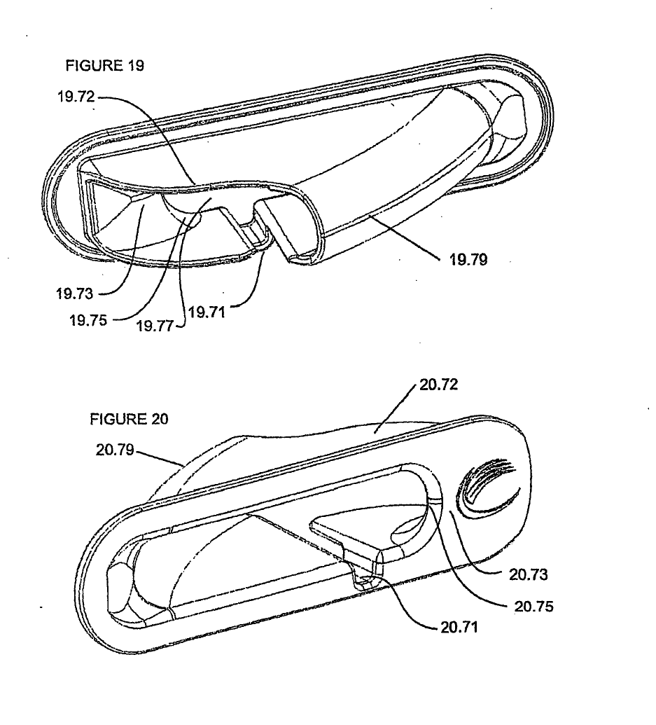

FIGS. 19 to 24 illustrate further embodiments of the invention adapted to accommodate electrical wiring.

In FIG. 19 the obround shape is further extended by an apron 19.73, and by the elongation of the chute curvature 19.79. The apron 19.73 has a rounded edge 19.75 facing the aperture 19.77. Again, the minimum curvature of the chute is kept above the minimum bending radius of the hose. The lateral edges of apron 19.73 and part of the aperture 19.77 are confined by skirt 19.72 which merges into the walls of the chute.

A channel 19.71 is provided for the passage of electrical wires or cables. The channel has a “C” shaped section. The channel also has rounded edges and corners. In use, the hole in the boom member to receive the chute is shaped to accommodate the channel 19.71.

FIG. 20 shows a second aspect of the chute of FIG. 19. In this view, the rounding of the edges of the channel 20.71 as it emerges from the beam can be seen. As can the rounding 20.75 of the apron 20.73.

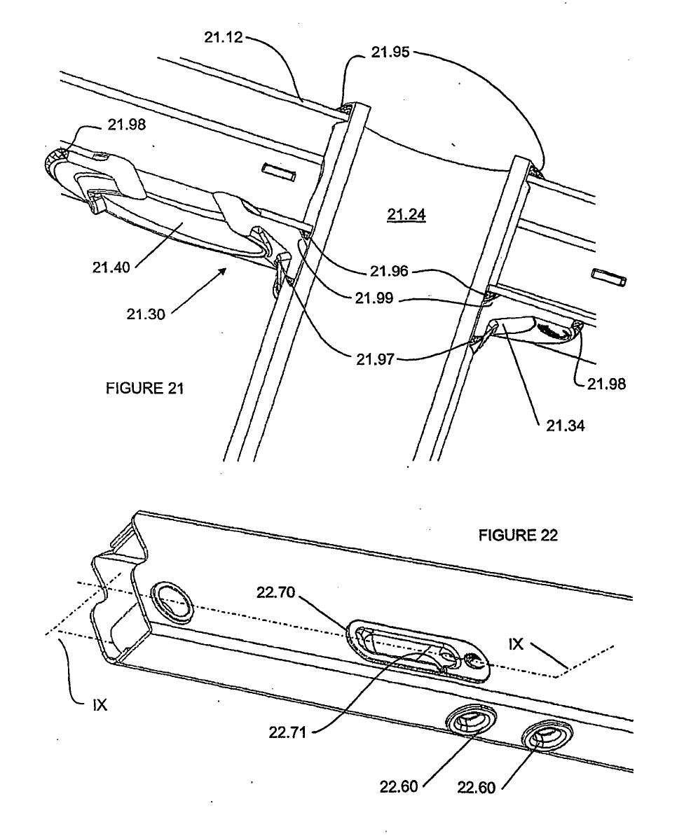

FIG. 21 is a section view of an arrangement such as shown in FIG. 4, illustrating the welds 21.95, 21.96, 21.97, and 21.98. The beam and the cross-bar are welded by a first pair of welds, and then the hose entry casting is welded to the beam, and then to the cross-bar. The beam 21.12 has a first circumferential weld 21.95, and a second circumferential weld 21.96 around the cross-bar 21.24. The obround hose entry casting 21.30 has an undulating circumferential weld 21.97 around the cross-bar, and a circumferential weld 21.98 to the beam 21.12. The casting includes an interior chamfer 21.99 to accommodate the beam/cross-bar weld 21.96.

FIG. 22 illustrates an arrangement similar to that of FIG. 5 including a chute as shown in FIG. 19 adapted to accommodate electrical wires or cables. The chute 22.70 includes wire channel 22.71.

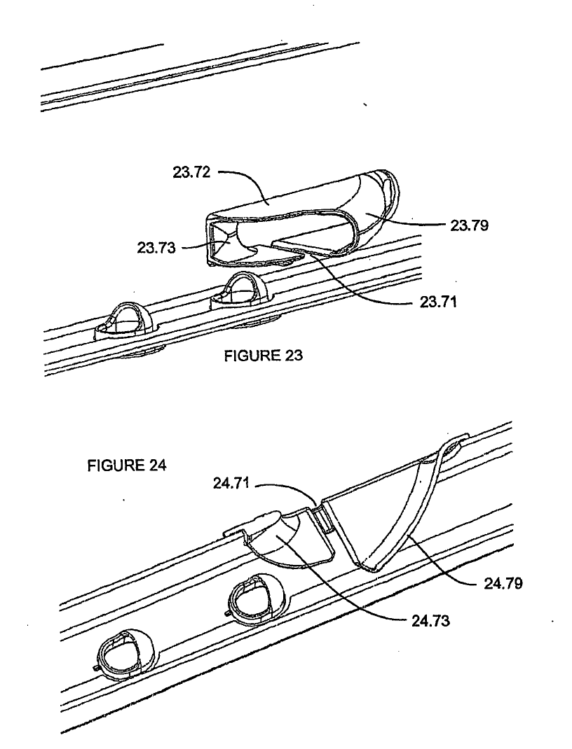

FIG. 23 is an “interior” view of the arrangement of FIG. 22. This figure illustrates the wire channel 23.71, the curved chute 23.79, the apron 23.73, and the skirt 23.72.

FIG. 24 is a section view along the plane defined by lines IX-IX of FIG. 22. The wire channel 24.71, the apron 24.73, and the curved chute 24.79 are again illustrated in this figure. As best shown in this figure, the wire channel 24.71 has a length which is less than the height of the skirt 24.72 at the location of the channel.

While the above described cowling system is indicated as having three cowling pieces, if required this could be reduced to a one or two piece system. While more pieces could be used this would require extra time for assembly and in most cases would thus not be desirable.

The above described arrangements and features ensure that the hoses do not engage sharp corners and remain protected during use, preventing damage and entanglement during operation of the boom assembly 10.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A method of constructing a boom assembly of a front end loader, said method including the step of providing connection of a first and second boom member with a cross bar via a pair of shaped plates which strengthen said connection while providing means for a hose to pass through said first or second boom to a location outside of said cross bar.

2. A method as claimed in claim 1, wherein said cross bar is welded at each of two ends to respective plates.

3. A method as claimed in claim 1 wherein each of said plates is respectively welded to said first and second boom.

4. A method as claimed in claim 1, wherein said shaped plates have a periphery which is adapted to be connected to said boom and a boss around an aperture through said plate, said aperture receiving said cross bar, said boss having a rim, such as a corrugated rim, on an end of said boss away from said plate such that the lineal length of said rim is larger than the lineal length of a circumference of said cross bar measured perpendicular to a longitudinal axis of said cross bar.

5. A method as claimed in claim 4, wherein said plate includes a second aperture through said plate for at least one of a hose and a cable to pass through, said second aperture being surrounded by a boss which is used for at least one of the following: securing said at least one of a hose and a cable to said plate; directing said at least one of a hose and a cable through said plate; securing a cover to said plate to overlie said at least one of a hose and a cable.

6. A method as claimed in claim 5, wherein said second aperture has, at its rim on the boom side of said plate, a radius to prevent said at least one of a hose and a cable from being damaged by said plate.

7. A method of constructing a boom assembly of a front end loader, said method including the step of providing connection of a first and a second boom member with a cross bar, said method including the step of joining said cross bar to said first and second boom members at respective inboard and outboard locations where the cross bar and boom members intersect and the step of attaching a plate via its perimeter to at least one of said inboard and outboard locations, said plate surrounding said cross bar, and joining said plate to said cross bar at a rim of said plate which surrounds said cross bar.

8. A method as claimed in claim 7 wherein said perimeter includes at least two opposed rounded ends.

9. A method as claimed in claim 7, wherein said rim includes a corrugated surface region.

10. A method as claimed in claim 7, wherein said plate includes a cylindrical wall extending between said rim and a base of said plate.

11. A method as claimed in claim 10, wherein said plate includes a boss formed on said plate from which said cylindrical wall extends.

12. A method as claimed in claim 11, wherein said plate includes a hose entry aperture.

13. A front end loader constructed by the method of claim 1.

14. A boom assembly for a front end loader, said boom assembly including first and second boom members with a cross bar interconnecting said first and second boom members, said cross bar being adapted to carry a component of a hydraulic system outward of an external surface region thereof, said assembly including a cowling system extending between said boom members and overlying said cross bar.

15. A boom assembly as claimed in claim 14, wherein said cross bar is joined to one of said boom members by a shaped plate, said shaped plate providing support and securement for said cowling system.

16. A boom assembly as claimed in claim 14, wherein said cowling system comprises one or more cowling pieces.

17. A boom assembly as claimed in claim 14 wherein said cowling system comprises at least two end pieces and one centre piece.

18. A boom assembly as claimed in claim 14, wherein said cowling system includes an aperture for a hose to pass into a volume bounded by said cowling system.

19. A boom assembly as claimed in claim 18, wherein said aperture is adapted to be covered by a panel, said panel being adapted to be popped out when required.
